(19) United States
(12) Patent Application Publication
(10) Pub. No.: US 2003/0236674 A1
(43) Pub. Date: Dec. 25, 2003

(54) Methods and systems for compression of stored audio

(76) Inventor: Raymond C. Henry JR., Wake Forest, NC (US)

Correspondence Address: MYERS BIGEL SIBLEY & SAJOVEC, PO BOX 37428, RALEIGH, NC, 27627, US

(21) Appl. No.: 10/175,311

(22) Filed: Jun. 19, 2002

(51) Int. Cl. G10L 21/00

(52) U.S. Cl. 704/500

(57) ABSTRACT

Methods, systems and computer program products for storing of an encoded audio record for local playback are provided. An audio record having symbol level prioritization and including a plurality of first priority symbols and a plurality of second priority symbols to be stored is provided. Ones of the second priority symbols are selected for discarding. The audio record is stored without storing the selected ones of the second priority symbols. The first priority symbols may be high priority symbols and the second priority symbols may be low priority symbols having a lower priority than the high priority symbols. The symbols may be bits and the audio records may be frames.

### BACKGROUND OF THE INVENTION

The present invention relates to the field of communications in general and more particularly, to audio communication.

A wide variety of different technologies are currently used to support audio (such as voice/speech) communications. These technologies range from the traditional public switched telephone networks (PSTN) to wireless communication networks and even to computer networks supporting packetized voice communications. For communication media, such as digital wireless phones and computer networks supporting voice communications, it is known to provide digitization of an analog speech signal using a variety of voice coder/decoders (“vocoder” or “voice codec”). A typical vocoder uses a frame-based coder-decoder algorithm where the algorithm is, typically, specified by the protocol governing the communication medium. Such algorithms may be designed for a lossy media (subject to noise), such as a wireless network or noisy wired system, and may include bit and/or frame error correction and/or frame replacement to correct for errors in transmission of the voice frames.

Examples of algorithms for known vocoders include those specified for the wireless communication standard IS-136, which supports Algebraic code-excited Linear Prediction (ACELP), Vector-Sum Excited Linear Prediction (VSELP) and United States-1 (US1) vocoders. Further examples for code division wireless communications include those supported by the CDMA 200 specification, which supports Qualcomm Code-Excited Linear Prediction (QCELP) and Enhanced Variable Rate CODEC (EVRC) vocoders. Similar specifications are known related to voice coding and decoding for other wireless communication protocols, such as the Global System for Mobile Communications (GSM) and for computer network based voice communication applications, such as voice over internet protocol (VoIP). More generally, vocoders are known that anticipate errors over a transmission media and provide protocols to allow for correction when such errors occur.

In some instances, it is desirable to store speech or other audio records so that they may be replayed at a later time. For example, a wireless phone may provide support for recoding voice memos from a user, some or all of an over the air conversation, audio voice tags and so on. It is known in wireless phones to provide support for compressing such speech to be stored locally on the wireless phone using an independent compression scheme running on an audio signal that starts out as an uncompressed signal, for example, a signal received from the microphone of the wireless phone. Examples of such an independent compression scheme are specified in Adaptive Differential Pulse Code Modulation (ADPCM), MU-LAW and Motion Picture Experts Group (MPEG).

### SUMMARY OF THE INVENTION

Embodiments of the present invention provide methods for storing of an encoded audio record for local playback. An audio record having symbol level prioritization and including a plurality of first priority symbols and a plurality of second priority symbols is provided. Ones of the second priority symbols are selected for discarding. The audio record is stored without storing the selected ones of the second priority symbols. The first priority symbols may be high priority symbols and the second priority symbols may be low priority symbols having a lower priority than the high priority symbols. The symbols may be bits and the audio records may be frames.

In other embodiments of the present invention, a plurality of encoded audio records having symbol level prioritization and including a plurality of high priority symbols and a plurality of low priority symbols having a lower priority than the high priority symbols are provided. Ones of the plurality of encoded audio records are selected for discarding and the plurality of encoded audio records are stored without storing the selected ones of the plurality of encoded audio records.

In further embodiments of the present invention, selecting ones of the second priority symbols for discarding includes providing a selection mask specifying symbol positions of the audio records to be discarded. The audio record is stored without storing ones of the lower priority symbols of the plurality of encoded audio records specified by the selection mask.

In other embodiments of the present invention, the stored audio record(s) is read. Replacement symbols (of random or known value) corresponding to the selected ones of the second priority symbols that were deleted are inserted in the read stored audio record to provide a reconstructed audio record of a correct length. The reconstructed audio record is decoded to provide a audio output signal. In addition, replacement audio records (which may be of a fixed, known value) may be added to the read encoded audio records corresponding to selected ones of the plurality of encoded audio records discarded during storage. The audio output record may be, for example, a voice memo, a voice tag or a recording. The number of second priority symbols to be discarded may be selected to provide a desired quality of an audio output signal generated from the stored audio record. Similarly, the number of ones of the plurality of encoded audio records to be discarded may be selected to provide a desired quality of an audio output signal generated from the stored audio record.

In further embodiments of the present invention, methods are provided for storing encoded voice frames including receiving a voice input to be stored. The received voice input is voice coded to provide at least one encoded voice frame. The encoded voice frame(s) have a plurality of first sensitivity bit positions and a plurality of second sensitivity bit positions. Ones of the second sensitivity bit positions are selected for discarding. Bits of the encoded voice frame(s) corresponding to the selected ones of the second sensitivity bit positions are discarded to provide at least one compressed encoded voice frame and the at least one compressed encoded voice frame is stored. The stored at least one compressed encoded voice frame is read. Replacement bits of random or known value corresponding in position to the discarded bits of the at least one encoded voice frame are inserted to provide a reconstructed voice frame of a desired length. The reconstructed voice frame is decoded to provide a voice output signal. The storage and retrieval operations may be performed in a mobile terminal.

In other embodiments of the present invention, methods are provided for storing encoded audio frames. An audio input to be stored is received. The received audio input is voice coded to provide a plurality of encoded audio frames. Selected ones of the plurality of encoded audio frames are discarded to provide a reduced number of encoded audio frames associated with the audio input to be stored. The reduced number of encoded audio frames are stored.

In further embodiments of the present invention, systems are provided for storing encoded audio records. The systems include a memory and a vocoder. The vocoder provides the encoded audio record(s). The audio record(s) have symbol level prioritization and include a plurality of first priority symbols and a plurality of second priority symbols. A processor selects ones of the second priority symbols for discarding and stores the audio record in the memory without storing the selected ones of the second priority symbols.

In other embodiments of the present invention, mobile terminals are provided. The mobile terminals include a memory and a vocoder that provides a plurality of encoded voice frames having symbol level prioritization and including a plurality of first priority symbols and a plurality of second priority symbols. A processor selects ones of the second priority symbols for discarding and stores the voice frames in the memory without storing the selected ones of the second priority symbols. The processor is further configured to read the stored voice frames and insert replacement symbols of random or known value corresponding in position to the selected ones of the second priority symbols in the read stored voice frames to provide reconstructed voice frames of a desired length. The vocoder is further configured to decode the reconstructed voice frames to provide an audio output signal.

### BRIEF DESCRIPTION OF THE DRAWINGS

FIG. 1 is a schematic block diagram illustrating a mobile terminal including a system for compressed storing of encoded audio records according to embodiments of the present invention;

FIG. 2 is flow chart illustrating operations for storing compressed encoded audio records according to embodiments of the present invention; and

FIG. 3 is a flow chart illustrating operation for playback of stored compressed encoded audio records according to embodiments of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as a method, system, or computer program product. Accordingly, the present invention may take the form of an entirely hardware embodiment, an entirely software embodiment or an embodiment combining software and hardware aspects, all generally referred to herein as a “circuit.” Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package. The processor(s) may be incorporated in a computer coupled to a network that supports voice (audio) communications or in an audio communication device, such as a wireless terminal. The supported audio communications may be through a local area network (LAN), a wide area network (WAN), a wireless communication media, a wired communication media or other such internetworking media, or the connection may be made through one or more external computers and/or data processing systems (for example, through the Internet using an Internet Service Provider or through a packet switched or circuit switched network, such as a telephony network).

The present invention is described below with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

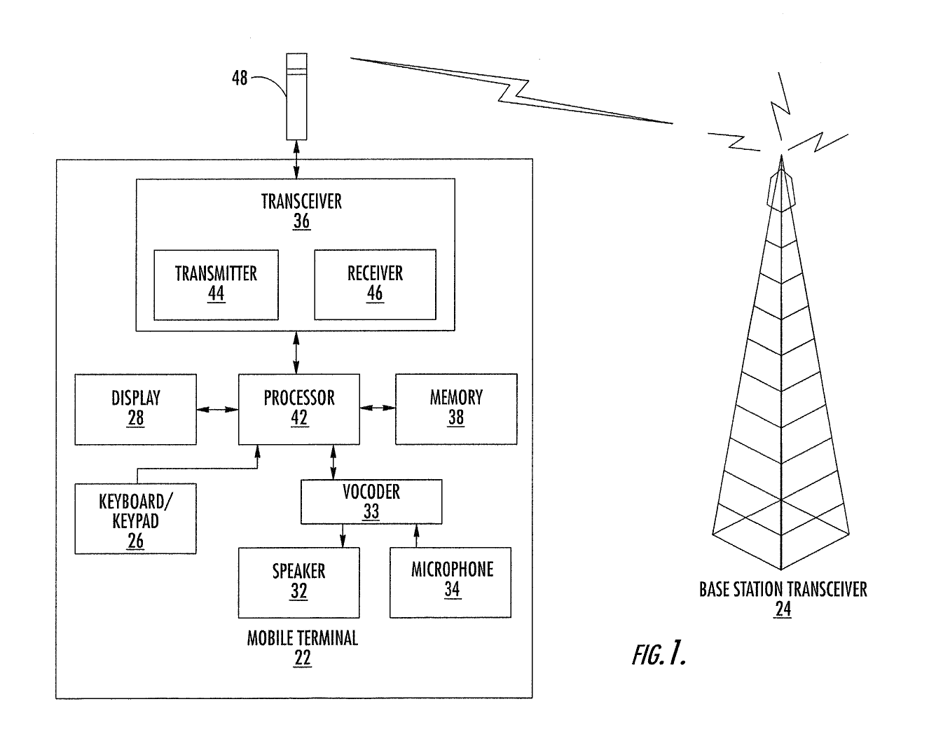

Embodiments of the present invention will now be described with reference to the schematic block diagram illustration of a wireless terminal in FIG. 1. FIG. 1 illustrates an exemplary radiotelephone communication system, in accordance with embodiments of the present invention, that includes mobile wireless terminal 22 and a base station transceiver 24. The mobile terminal 22 may comprise a keyboard/keypad 26, a display 28, a speaker 32, a microphone 34, a transceiver 36, and a memory 38 that communicate with a processor 42. The transceiver 36 typically comprises a transmitter circuit 44 and a receiver circuit 46, which respectively transmit outgoing radio frequency signals to the base station transceiver 24 and receive incoming radio frequency signals from the base station transceiver 24 via an antenna 48. The radio frequency signals transmitted between the mobile terminal 22 and the base station transceiver 24 may comprise both traffic and control signals (e.g., paging signals/messages for incoming calls), which are used to establish and maintain communication with another party or destination.

The foregoing components of the mobile terminal 22 may be included in many conventional mobile terminals and their functionality is generally known to those skilled in the art. It should be further understood, that, as used herein, the term “mobile terminal” may include a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

The base station transceiver 24 comprises the radio transceiver(s) that define an individual cell in a cellular network and communicate with the mobile terminal 22 and other mobile terminals in the cell using a radio-link protocol. Although only a single base station transceiver 24 is shown, it will be understood that many base station transceivers may be connected through, for example, a mobile switching center and other devices to define a wireless communication network.

In accordance with the illustrated embodiments of the present invention, a vocoder 33 is provided to interface the speaker 32 and the microphone 34 with the processor 42. In the wireless terminal of FIG. 1, speech from the user or other audio signals are detected, typically, as analog signals by the microphone 34 and then passed through one or more voice processing stages, which may be incorporated with the vocoder 33 are provided separately to prepare an input signal to the vocoder 33. The pre-coding voice processing stages may include audio level adjustment, bandpass filtering and analog-to-digital conversion (e.g., 13-bit linear PCM format or 8-bit MU-law format) followed by additional high-pass filtering.

The vocoder 33 may be one of a variety of different known coder/decoders and may use a voice compression algorithm (e.g., ACELP or VSELP) to compress the voice signal into a low-rate data bit stream (e.g., from 64 kbps to 8 kbps) and/or other known techniques providing an error recovery mechanism(s). Additional error protection and/or correction techniques may be applied by the vocoder 33 or a separate channel coder to the data stream, for example, a symbol level prioritization assignment (at least first and second priority symbols with one being a higher priority than the other) and differential coding approach such as using a rate one-half convolutional code to protect the more vulnerable/important bits of the voice coder data stream. Other approaches may be used, such as a Cyclic Redundancy Check (CRC) over some of the most perceptually significant bits of the voice coder frame.

In accordance with various embodiments of the present invention, the processor 42 receives encoded audio records from the vocoder 33 and stores the encoded audio records in the memory 38 using compressed storage of the encoded audio records. Thus, in various embodiments of the present invention, the processor 42 is configured to select ones of the symbols associated with one of the symbol priorities for discarding and is configured to store the corresponding voice records in the memory 38 without storing the selected ones of the symbols. The processor 42 may be further configured to read the stored records from the memory 38, decompress the read records and provide them to the vocoder 33. The vocoder 33, in turn, may decode the decompressed records to provide a voice output signal that may be played back, for example, on the speaker 32.

Various vocoders 33 have two types of error recovery mechanisms in addition to providing compression of the amount of data that needs to be transmitted over the communication medium. The first type of error recovery mechanism, as discussed above, may be applied at a symbol (or bit for binary symbols) level. For the bits received by the vocoder 33, priorities (of two or more levels) are assigned, for example, according to the bits' sensitivity to errors. The least sensitive bits are able to contain errors substantially without affecting the perceivable quality of the speech (or other audio signal). The vocoder 33 may have different priority categories, different numbers of categories and different error thresholds on each. However, at least for vocoders in mobile terminal applications for wireless networks, the vocodor 33 has some degree of bit-level prioritization.

A second error mechanism that may be provided occurs when a frame of audio data is received with so many errors that the entire frame is declared unusable. In this situation, a vocoder 33 may provide a frame replacement feature. In such a case, the entire received frame is discarded and a “noise” or other replacement frame is inserted to fill the time period associated with the discarded (or lost) frame. In typical wireless mobile terminal vocoders, the frame time may be about 20 milliseconds and may contain a number of bits from about 400 to about 600.

Although the present invention may be embodied in communication devices or systems, such as the mobile terminal 22 and/or the base station transceiver 24, the present invention is not limited to such devices and/or systems. Instead, the present invention may be embodied in any method, transmitter, communication device, communication system, or computer program product that stores audio records in which the underlying audio signal is encoded with one or more error recovery mechanisms. Exemplary audio records that may be processed in accordance with the present invention include voice memos, voice tags and/or recordings. Although the invention is illustrated for use with a wireless mobile terminal, it will be understood that the invention is applicable to any wireless communications system such as a cellular base station or wireless communications infrastructure or to other types of systems in which vocoders are used to support transmission of audio records with error recovery mechanisms provided by the vocoders.

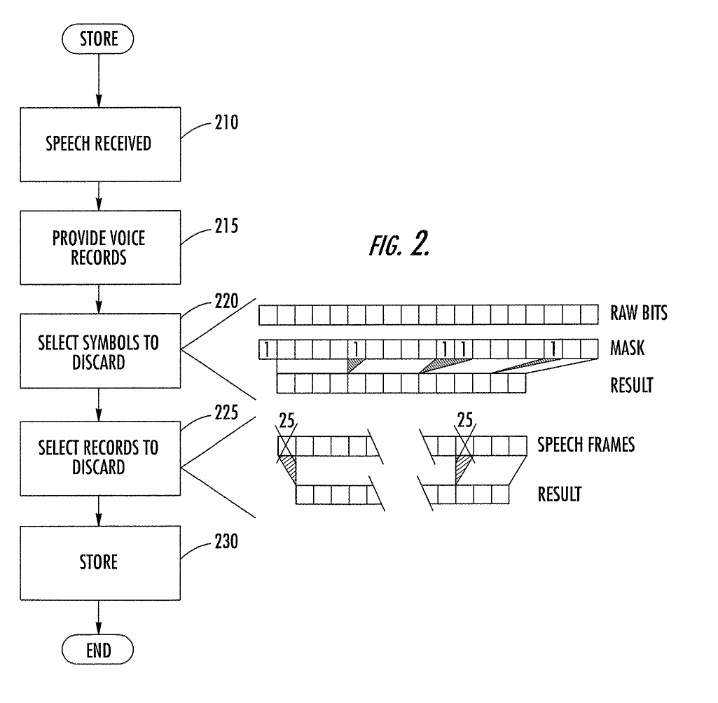

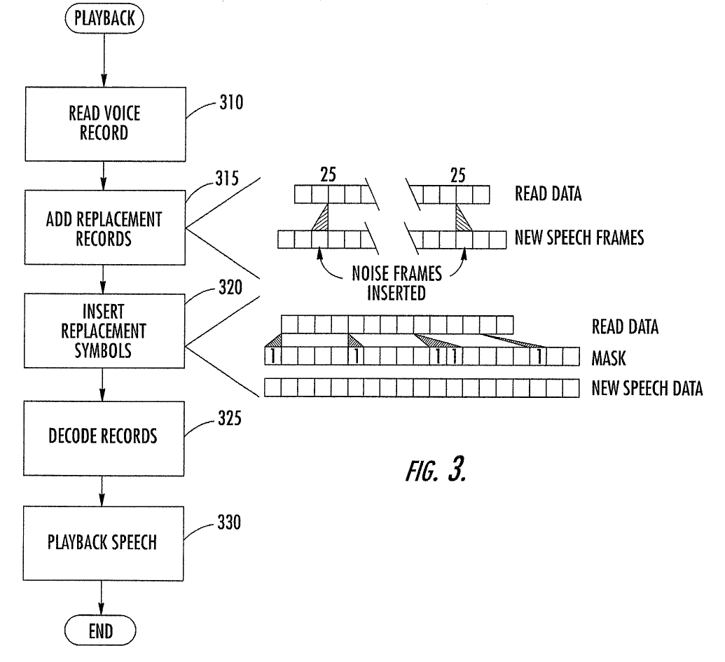

FIGS. 2 and 3 are flowchart illustrations of operations that may be carried out by the mobile terminal 22, or other audio processing device, with storage of audio signal records for local play back according to embodiments of the present invention. As will be described below, various embodiments of the present invention use the error recovery mechanism(s) associated with the vocoder 33 to reduce the number of symbols that need to be stored for various types of audio segments in a device, such as the mobile terminal 22. For example, upon recording a voice tag to go along with a stored dial number, the vocoder 33 could be run to encode the speech. While storing, embodiments of the present invention may skip the storing of, for example, 50% of the lowest sensitivity (priority) bits and/or not store selected ones (for example, one out of every 25) of the frames entirely. Furthermore, it is to be understood that variations on the embodiments of the present invention are encompassed within the present invention, such as providing varying numbers of low-sensitivity bits and frame erasures to trade-off memory storage requirements and the resulting voice quality of the played back speech. As the error recovery mechanisms are found in the vocoder 33, the compressed storage provided by various embodiments of the present invention may be provided at no additional cost. In other words, the error recovery mechanisms provided by a vocoder 33 to address error sensitive transmission environments may not be needed for local playback so the associated locally stored audio records can be compressed in accordance with embodiments of the present invention given the substantially error free environment of memory storage for local playback.

Referring now to FIG. 2 operations for storing of an encoded audio record according to embodiments of the present invention will now be described. Operations begin at Block 210 with receipt of an audio signal, such as a speech or voice input from the speaker 32. One or more audio records are then provided from the audio signal by the vocoder 33 at Block 215. The audio records from the vocoder 33 have symbol (typically bit) level prioritization and include a plurality of first priority symbols and a plurality of second priority symbols. In various embodiments, the first priority symbols may be high priority symbols and the second priority symbols may be low priority symbols having a lower priority than the high priority symbols.

One or more of the second priority symbols are selected for discarding at Block 220. For example, as shown in the exemplary bit block diagram adjacent Block 220 of FIG. 2, a selection mask may be provided specifying symbol (bit as shown in FIG. 2) positions of the audio records to be discarded. As shown in FIG. 2, the positions of the mask having a “1” value designate corresponding raw bits of the voice record designated for discarding to result in the reduced bit count compressed result record shown in FIG. 2.

In particular embodiments of the present invention, further compression before storing may be provided by selecting ones of a plurality of encoded audio records for discarding at Block 225. As illustrated in FIG. 2 for speech frame audio records, one out of every twenty five speech frames is selected for discarding at Block 225. The audio record or records may then be stored at Block 230 without storing the selected ones of the second priority symbols and without storing the selected ones of the plurality of encoded voice records.

The number of the second priority symbols to be discarded may be selected at Block 230 to provide a desired quality of an audio output signal generated from the stored audio record(s) during play back. For example, in a mobile terminal, the quality of playback of a voice tag locally at the mobile terminal could be controlled by the number of symbols discarded. Similarly, the number of ones of the plurality of encoded audio records selected for discarding at Block 225 may be chosen to provide a desired quality of an audio output signal generated from a stored audio record(s).

By way of particular example, for example, in connection with a wireless mobile terminal 22, the received speech at Block 210 may be a voice memo, a voice tag, or a recoding of an input voice signal from the microphone 34 or received from the transceiver 36. The voice input is coded at Block 215 to provide at least one encoded voice frame having a plurality of first sensitivity bit positions and second sensitivity bit positions. Selected ones of the second sensitivity bits positions are selected for discarding at Block 220 and bits of the encoded voice frame(s) corresponding to the selected ones of the second sensitivity bits positions are discarded to provide one or more compressed encoded voice frames. The compressed encoded voice frames are then stored at Block 230. For example, the second sensitivity bits may be low-sensitivity bits that are selected for discarding by a selection mask. Similarly, as discussed above, selected ones of the voice frames may be discarded. In alternative embodiments, compression may be provided only through discarding of selected bits or only through discarding of selected ones of the encoded audio records or as described above, both approaches may be utilized to compress the audio records before storage.

Operations related to playback of the compressed stored audio records will now be further described with reference to FIG. 3. As shown in the embodiments of FIG. 3, operations begin with reading of the stored audio record(s) at Block 310, for example, responsive to a request from a user of the mobile terminal 22. In particular embodiments of the present invention, where the stored encoded voice records read at Block 310 were subjected to compression by deletion of ones of the audio records, replacement audio records are added to the read plurality of encoded audio records, the replacement audio records corresponding to the ones of the plurality of encoded audio records that were deleted before storage at Block 225.

Replacement symbols corresponding to the selected ones of the second priority symbols deleted before storage of the audio records are inserted into the read audio records at Block 320. For example, a schematic bit block diagram of exemplary operations is shown adjacent Block 320 in FIG. 3 corresponding to the example compression operation described with the reference to Block 220 of FIG. 2. In particular, a corresponding selection mask is utilized to designate bit positions where replacement bits are inserted to fill the audio record to create the new audio record (or speech frame as shown in FIG. 3) of the desired length at Block 320. The reconstructed audio record(s) are then decoded to provide a voice output signal at Block 325. For example, normal vocoder “decode” operations may be applied to the reconstructed audio records. The speech may then be played back at Block 330.

The flowcharts, flow diagrams and block diagrams of FIGS. 1 through 3 illustrate the architecture, functionality, and operation of possible implementations of systems, methods and computer program products for providing streaming data services. In this regard, each block in the flow charts or block diagrams may represent a module, segment, or portion of code, which comprises one or more executable instructions for implementing the specified logical act(s). It should also be noted that, in some alternative implementations, the acts noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method for storing of an encoded audio record for local playback comprising:
providing the audio record, the audio record having symbol level prioritization and including a plurality of first priority symbols and a plurality of second priority symbols;
selecting ones of the second priority symbols for discarding; and
storing the audio record without storing the selected ones of the second priority symbols.

2. The method of claim 1 wherein the first priority symbols comprise high priority symbols and the second priority symbols comprise low priority symbols having a lower priority than the high priority symbols.

3. The method of claim 2 wherein providing the audio record comprises providing a plurality of encoded audio records having symbol level prioritization and including a plurality of high priority symbols and a plurality of low priority symbols having a lower priority than the high priority symbols, the method further comprising selecting ones of the plurality of encoded audio records for discarding, and wherein storing the audio record further comprises storing the plurality of encoded audio records without storing the selected ones of the plurality of encoded audio records.

4. The method of claim 3 wherein selecting ones of the second priority symbols for discarding comprises providing a selection mask specifying symbol positions of the audio records to be discarded, and wherein storing the audio record without storing the selected ones of the second priority symbols comprises storing the audio records without storing ones of the lower priority symbols of the plurality of encoded audio records specified by the selection mask.

5. The method of claim 4 wherein the symbols comprise bits and the audio records comprise frames.

6. The method of claim 2 wherein selecting ones of the second priority symbols for discarding comprises providing a selection mask specifying symbol positions of the audio record to be discarded, and wherein storing the audio record without storing the selected ones of the second priority symbols comprises storing the audio record without storing ones of the lower priority symbols of the audio record specified by the selection mask.

7. The method of claim 6 wherein the symbols comprise bits and the audio records comprise frames.

8. The method of claim 1 further comprising:
reading the stored audio record;
inserting replacement symbols corresponding to the selected ones of the second priority symbols in the read stored audio record to provide a reconstructed audio record; and
decoding the reconstructed audio record to provide a audio output signal.

9. The method of claim 3 further comprising:
reading the stored plurality of encoded audio records;
adding replacement audio records to the read plurality of encoded audio records corresponding to the selected ones of the plurality of encoded audio records;
inserting replacement symbols corresponding to the selected ones of the second priority symbols in the read stored plurality of audio records; and then
decoding the plurality of encoded audio records including the added replacement audio records and inserted replacement symbols to provide a audio output signal.

10. The method of claim 9 wherein the audio output record comprises at least one of a voice memo, a voice tag and a recording.

11. The method of claim 1 further comprising selecting a number of ones of the second priority symbols to be discarded to provide a desired quality of an audio output signal generated from the stored audio record.

12. The method of claim 3 further comprising selecting a number of ones of the plurality of encoded audio records to be discarded to provide a desired quality of an audio output signal generated from the stored audio record.

13. A method for storing and retrieving encoded voice frames comprising:
receiving a voice input to be stored;
voice coding the received voice input to provide at least one encoded voice frame, the at least one encoded voice frame having a plurality of first sensitivity bit positions and a plurality of second sensitivity bit positions;
selecting ones of the second sensitivity bit positions for discarding;
discarding bits of the at least one encoded voice frame corresponding to the selected ones of the second sensitivity bit positions to provide at least one compressed encoded voice frame;
storing the at least one compressed encoded voice frame;
reading the stored at least one compressed encoded voice frame;
inserting replacement bits corresponding to the discarded bits of the at least one encoded voice frame to provide a reconstructed voice frame; and
decoding the reconstructed voice frame to provide a voice output signal.

14. The method of claim 13 wherein the voice input comprises at least one of a voice memo, a voice tag and a recording.

15. The method of claim 13 wherein the second sensitivity is lower than the first sensitivity.

16. The method of claim 13 wherein the operations are carried out in a mobile terminal.

17. The method of claim 13 wherein selecting ones of the second sensitivity bit positions for discarding comprises providing a selection mask specifying bit positions of the at least one encoded voice frame to be discarded, and wherein discarding bits of the at least one encoded voice frame corresponding to the selected ones of the second sensitivity bit positions comprises discarding bits of the at least one encoded voice frame specified by the selection mask to provide the at least one compressed encoded voice frame.

18. The method of claim 13:
wherein the at least one encoded voice frame comprises a plurality of encoded voice frames;
wherein the method further comprises discarding selected ones of the plurality of encoded voice frames to provide a reduced number of encoded voice frames associated with the voice input to be stored;
wherein discarding bits of the at least one encoded voice frame corresponding to the selected ones of the second sensitivity bit positions to provide at least one compressed encoded voice frame comprises discarding bits of the reduced number of encoded voice frames corresponding to the selected ones of the second sensitivity bit positions to provide a plurality of compressed encoded voice frames; and
wherein storing the at least one compressed encoded voice frame comprises storing the plurality of compressed encoded voice frames.

19. The method of claim 18 wherein reading the stored at least one compressed encoded voice frame comprises reading the stored plurality of compressed encoded voice frames, and wherein the method further comprising adding replacement voice frames to the read plurality of compressed encoded voice frames corresponding to the discarded selected ones of the plurality of encoded voice frames and wherein inserting replacement bits comprises inserting replacement bits corresponding to discarded bits of the reduced number of encoded voice frames in the read stored plurality of voice records, and wherein decoding the reconstructed voice frame comprises decoding the plurality of compressed encoded voice frames including the added replacement voice frames and the inserted replacement bits to provide a voice output signal.

20. A method for storing encoded audio frames comprising:
receiving an audio input to be stored;
voice coding the received audio input to provide a plurality of encoded audio frames;
discarding selected ones of the plurality of encoded audio frames to provide a reduced number of encoded audio frames associated with the audio input to be stored;
storing the reduced number of encoded audio frames.

21. The method of claim 20 further comprising:
reading the stored reduced number of encoded audio frames;
adding replacement audio frames to the read reduced number of encoded audio frames corresponding to the discarded selected ones of the plurality of encoded audio frames to provide a supplemented plurality of encoded audio frames; and then
decoding the supplemented plurality of encoded audio frames to provide an audio output signal.

22. A system for storing of an encoded audio record comprising:
a memory;
a vocoder that provides the encoded audio record, the audio record having symbol level prioritization and including a plurality of first priority symbols and a plurality of second priority symbols; and
a processor that selects ones of the second priority symbols for discarding and stores the audio record in the memory without storing the selected ones of the second priority symbols.

23. The system of claim 22 wherein the vocoder provides a plurality of encoded audio records having symbol level prioritization and including a plurality of high priority symbols and a plurality of low priority symbols having a lower priority than the high priority symbols, wherein the processor is further configured to select ones of the plurality of encoded audio records for discarding and to store the plurality of encoded audio records without storing the selected ones of the plurality of encoded audio records.

24. The system of claim 23 further comprising a selection mask that specifies symbol positions of the audio records to be discarded, and wherein the processor is further configured to store the plurality of encoded audio records without storing ones of the lower priority symbols of the plurality of encoded audio records specified by the selection mask.

25. The system of claim 24 wherein the symbols comprise bits and the audio records comprise frames.

26. The system of claim 22 wherein the processor is further configured to read the stored audio record and to insert replacement symbols corresponding to the selected ones of the second priority symbols in the read stored audio record to provide a reconstructed audio record and wherein the vocoder is further configured to decode the reconstructed audio record to provide an audio output signal.

27. The system of claim 23 where the processor is configured to read the stored plurality of encoded audio records and to add replacement audio records to the read plurality of encoded audio records corresponding to the selected ones of the plurality of encoded audio records and to insert replacement symbols corresponding to the selected ones of the second priority symbols in the read stored plurality of audio records and wherein the vocoder is further configured to decode the plurality of encoded audio records including the added replacement audio records and inserted replacement symbols to provide an audio output signal.

28. The system of claim 27 wherein the audio output record comprises at least one of a voice memo, a voice tag and a recording.

29. A system for storing of an encoded audio record for local playback comprising:
means for providing the audio record, the audio record having symbol level prioritization and including a plurality of first priority symbols and a plurality of second priority symbols;
means for selecting ones of the second priority symbols for discarding; and
means for storing the audio record without storing the selected ones of the second priority symbols.

30. A system for storing and retrieving of encoded voice frames comprising:
means for receiving a voice input to be stored;
means for voice coding the received voice input to provide at least one encoded voice frame, the at least one encoded voice frame having a plurality of first sensitivity bit positions and a plurality of second sensitivity bit positions;
means for selecting ones of the second sensitivity bit positions for discarding;
means for discarding bits of the at least one encoded voice frame corresponding to the selected ones of the second sensitivity bit positions to provide at least one compressed encoded voice frame;
means for storing the at least one compressed encoded voice frame;
means for reading the stored at least one compressed encoded voice frame;
means for inserting replacement bits corresponding to the discarded bits of the at least one encoded voice frame to provide a reconstructed voice frame; and
means for decoding the reconstructed voice frame to provide a voice output signal.

31. The system of claim 30 wherein the means for selecting ones of the second sensitivity bit positions for discarding includes a selection mask specifying bit positions of the at least one encoded voice frame to be discarded, and wherein the means for discarding bits of the at least one encoded voice frame corresponding to the selected ones of the second sensitivity bit positions comprises means for discarding bits of the at least one encoded voice frame specified by the selection mask to provide the at least one compressed encoded voice frame.

32. The system of claim 30 wherein the means for voice coding comprises means for voice coding the received voice input to provide a plurality of encoded voice frames, the system further comprising:
means for discarding selected ones of the plurality of encoded voice frames to provide a reduced number of encoded voice frames associated with the voice input to be stored;
wherein the means for discarding bits of the at least one encoded voice frame corresponding to the selected ones of the second sensitivity bit positions to provide at least one compressed encoded voice frame comprises means for discarding bits of the reduced number of encoded voice frames corresponding to the selected ones of the second sensitivity bit positions to provide a plurality of compressed encoded voice frames; and
wherein the means for storing the at least one compressed encoded voice frame comprises means for storing the plurality of compressed encoded voice frames.

33. A system for storing encoded audio frames comprising:
means for receiving an audio input to be stored;
means for voice coding the received audio input to provide a plurality of encoded audio frames;
means for discarding selected ones of the plurality of encoded audio frames to provide a reduced number of encoded audio frames associated with the audio input to be stored; and
means for storing the reduced number of encoded audio frames.

34. A computer program product for storing of an encoded audio record for local playback, the computer program product comprising:
a computer readable storage medium having computer readable program code embodied in said medium, said computer readable program code comprising:
computer readable program code that provides the audio record, the audio record having symbol level prioritization and including a plurality of first priority symbols and a plurality of second priority symbols;
computer readable program code that selects ones of the second priority symbols for discarding; and
computer readable program code that stores the audio record without storing the selected ones of the second priority symbols.

35. A computer program product for storing and retrieving of encoded voice frames, the computer program product comprising:
a computer readable storage medium having computer readable program code embodied in said medium, said computer readable program code comprising:
computer readable program code that receives a voice input to be stored;
computer readable program code that voice codes the received voice input to provide at least one encoded voice frame, the at least one encoded voice frame having a plurality of first sensitivity bit positions and a plurality of second sensitivity bit positions;
computer readable program code that selects ones of the second sensitivity bit positions for discarding;
computer readable program code that discards bits of the at least one encoded voice frame corresponding to the selected ones of the second sensitivity bit positions to provide at least one compressed encoded voice frame;
computer readable program code that stores the at least one compressed encoded voice frame;
computer readable program code that reads the stored at least one compressed encoded voice frame;
computer readable program code that inserts replacement bits corresponding to the discarded bits of the at least one encoded voice frame to provide a reconstructed voice frame; and
computer readable program code that decodes the reconstructed voice frame to provide a voice output signal.

36. The computer program product of claim 35 wherein the computer readable program code that selects ones of the second sensitivity bit positions for discarding includes a selection mask specifying bit positions of the at least one encoded voice frame to be discarded, and wherein the computer readable program code that discards bits of the at least one encoded voice frame corresponding to the selected ones of the second sensitivity bit positions comprises computer readable program code that discards bits of the at least one encoded voice frame specified by the selection mask to provide the at least one compressed encoded voice frame.

37. The computer program product of claim 35 wherein the computer readable program code that voice codes comprises computer readable program code that voice codes the received voice input to provide a plurality of encoded voice frames, the computer program product further comprising:
computer readable program code that discards selected ones of the plurality of encoded voice frames to provide a reduced number of encoded voice frames associated with the voice input to be stored;
wherein the computer readable program code that discards bits of the at least one encoded voice frame corresponding to the selected ones of the second sensitivity bit positions to provide at least one compressed encoded voice frame comprises computer readable program code that discards bits of the reduced number of encoded voice frames corresponding to the selected ones of the second sensitivity bit positions to provide a plurality of compressed encoded voice frames; and
wherein the computer readable program code that stores the at least one compressed encoded voice frame comprises computer readable program code that stores the plurality of compressed encoded voice frames.

38. A computer program product for storing encoded voice frames, the computer program product comprising:
a computer readable storage medium having computer readable program code embodied in said medium, said computer readable program code comprising:
computer readable program code that receives a voice input to be stored;
computer readable program code that voice codes the received voice input to provide a plurality of encoded voice frames;
computer readable program code that discards selected ones of the plurality of encoded voice frames to provide a reduced number of encoded voice frames associated with the voice input to be stored; and
computer readable program code that stores the reduced number of encoded voice frames.

39. A mobile terminal comprising:
a memory;
a vocoder that provides a plurality of encoded voice frames having symbol level prioritization and including a plurality of first priority symbols and a plurality of second priority symbols;
a processor that selects ones of the second priority symbols for discarding and stores the voice frames in the memory without storing the selected ones of the second priority symbols and that reads the stored voice frames and inserts replacement symbols corresponding to the selected ones of the second priority symbols in the read stored voice frames to provide reconstructed voice frames; and
wherein the vocoder is further configured to decode the reconstructed voice frames to provide an audio output signal.

40. The mobile terminal of claim 39 wherein the processor is further configured to select ones of the plurality of encoded voice frames for discarding and to store the plurality of encoded voice frames without storing the selected ones of the plurality of encoded audio records.
